(19) United States
(12) Patent Application Publication
(10) Pub. No.: US 2024/0298211 A1
(43) Pub. Date: Sep. 5, 2024

(54) USER EQUIPMENT (UE), COMMUNICATION SYSTEM, AND COMMUNICATION METHOD

(71) Applicant: SHARP KABUSHIKI KAISHA, Sakai City, Osaka (JP)

(72) Inventors: Koichi KANAMORI, Sakai City, Osaka (JP); SHIGETO SUZUKI, Sakai City, Osaka (JP); HIDEAKI SHINMEI, Sakai City, Osaka (JP); KENNICHI IIJIMA, Sakai City, Osaka (JP); MAKOTO YAMAMOTO, Sakai City, Osaka (JP)

(21) Appl. No.: 18/690,088

(22) PCT Filed: Mar. 3, 2022
(86) PCT No.: PCT/JP2022/009022

§ 371 Date: Mar. 7, 2024

(30) Foreign Application Priority Data
Sep. 8, 2021 (JP) 2021-145877

(51) Int. Cl. H04W 28/02; H04W 72/543

(52) U.S. Cl. CPC H04W 28/0289; H04W 72/543

(57) ABSTRACT

To provide a User Equipment (UE), a communication system, and a communication method that are capable of reducing an arrival time of communication and improving stability or reliability of communication. A User Equipment (UE) includes a communication unit that can transmit data to a first base station, and a control unit that controls transmission of data by the communication unit. The control unit determines whether the data is specific data, and in a case of determining that the data is the specific data, transmits the specific data from the communication unit to a second base station different from the first base station.

### TECHNICAL FIELD

The disclosure relates to a User Equipment (UE), a communication system, and a communication method. This application claims priority based on JP 2021-145877 filed on Sep. 8, 2021, the contents of which are incorporated herein by reference.

### BACKGROUND ART

In a known system including a base station and a mobile station, a technique for improving Quality of Service (QoS), i.e., quality of communication has been sought. For example, PTL 1 discloses the disclosure in which a first base station requests suppressing use of a resource from a second base station in a case that QoS of a packet communicated between the first base station and a mobile station is not ensured. With this configuration, the disclosure disclosed in PTL 1 attempts to improve the QoS of the entire system and effectively use resources by reducing interference to the mobile station due to the use of resources by the second base station.

### CITATION LIST

### Patent Literature

PTL 1: JP 2003-199144 A

### SUMMARY

### Technical Problem

In the disclosure disclosed in PTL 1, a prescribed determination procedure needs to be performed to improve the QoS and to effectively use the resources, but this determination procedure may take time. For this reason, it may not be appropriate to perform this determination procedure which takes time, for example, in an emergency.

In addition, although the disclosure disclosed in PTL 1 is intended to improve the QoS of the entire system and to effectively use the resources, in a case that the number of mobile stations in the system increases, communication congestion may occur, and as a result, communication may be unstable. However, communication is required to be performed quickly or reliably depending on a content of data to be communicate. For example, data with high urgency or importance is required to be communicated quickly or reliably.

The present disclosure has been made in view of the above-described problem. An object of the present disclosure is to provide a User Equipment (UE), a communication system, and a communication method that are capable of reducing an arrival time of communication and improving stability or reliability of communication.

### Solution to Problem

A User Equipment (UE) according to an aspect of the present disclosure includes a communication unit that can transmit data to a first base station, and a control unit that controls transmission of data by the communication unit. The control unit determines whether the data is specific data, and in a case of determining that the data is the specific data, transmits the specific data from the communication unit to a second base station different from the first base station.

A communication system according to an aspect of the present disclosure includes a first base station, a second base station different from the first base station, and a User Equipment (UE) that can transmit data to the first base station. The UE determines whether the data is specific data, and in a case of determining that the data is the specific data, transmits the specific data to the second base station.

A communication method according to an aspect of the present disclosure is a communication method performed by a User Equipment (UE) that can transmit data to a first base station and includes the steps of determining whether the data is specific data, and transmitting, in a case that the data is determined to be the specific data, the specific data to a second base station different from the first base station.

### BRIEF DESCRIPTION OF DRAWINGS

FIG. 1 is a diagram illustrating a schematic configuration of a communication system according to an embodiment.

FIG. 2 is a function block diagram illustrating an example of configuration of the communication system of FIG. 1.

FIG. 3 is a sequence diagram illustrating an example of processing by the communication system of FIG. 2.

FIG. 4 is a flowchart illustrating an example of processing performed by a UE of FIG. 2.

FIG. 5 is a sequence diagram illustrating an example of processing by a known communication system.

### DESCRIPTION OF EMBODIMENTS

Embodiments of the present disclosure will be described below with reference to the drawings. Note that in the drawings, the same or equivalent components are denoted by the same reference numerals and duplicate description of the same or equivalent components will be omitted.

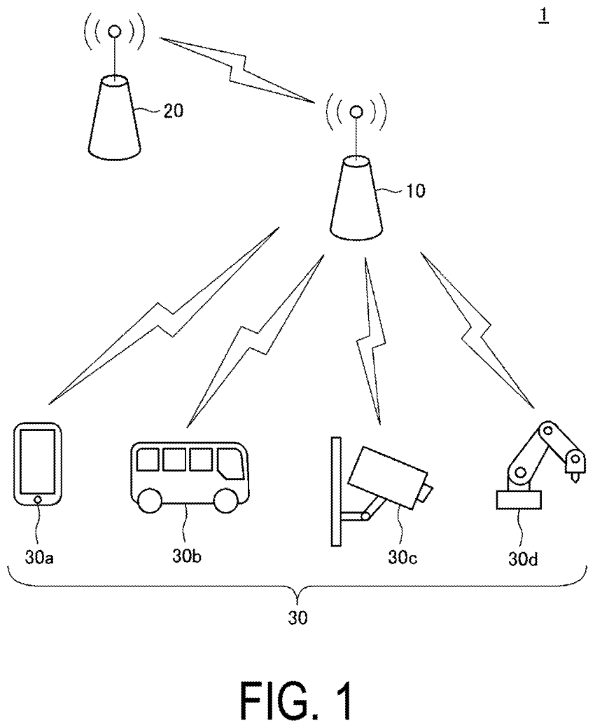

FIG. 1 is a diagram illustrating a schematic configuration of a communication system 1 according to an embodiment. As illustrated in FIG. 1, the communication system 1 includes a first base station 10, a second base station 20, and multiple User Equipments (UEs) 30.

Each of the first base station 10 and the second base station 20 provide a communication network based on a prescribed radio communication scheme. The prescribed radio communication scheme may be a communication scheme using a fifth generation mobile communication system (5G system). However, the prescribed radio communication scheme is not limited to the communication scheme using the 5G system, and may be another radio communication scheme.

The first base station 10 and the second base station 20 are configured to be able to communicate information with each other. In the present embodiment, stored data is synchronized between the first base station 10 and the second base station 20. The data synchronized between the first base station 10 and the second base station 20 may be data required for radio communication. The data required for radio communication may include, for example, information related to the UE 30, and control information, time, channel information, and frequency information required for performing communication control. For example, the first base station 10 and the second base station 20 can regularly, irregularly, or constantly transmit and/or receive data to and from each other to synchronize the stored data. The first base station 10 and the second base station 20 can synchronizing the data to perform the same processing or perform cooperative processing. Note that although the communication system 1 here is described as including two base stations, the first base station 10 and the second base station 20, the number of base stations included in the communication system 1 is not limited to two. The communication system 1 may include three or more base stations. In this case, the processing performed by the first base station 10 and the second base station 20 described in the present embodiment may be performed by those three or more base stations.

In the present embodiment, the first base station 10 and the second base station 20 are connected to the multiple UEs 30 to be able to communicate information with each other. Each of the multiple UEs 30, in a case of transmitting uplink communication data, determines whether the uplink communication data is specific data. Details of the specific data is described later.

In the present embodiment, in a case that the uplink communication data is normal data, the UE 30 transmits the uplink communication data to the first base station 10. In other words, in a case that the normal data is transmitted and/or received, information is communicated between the first base station 10 and the UE 30. Here, the normal data is data other than the specific data.

In the present embodiment, the multiple UEs 30 do not transmit and/or receive the normal data to and from the second base station 20. In other words, although the second base station 20 is connected to the multiple UEs 30 to be able to communicate information with each other, the second base station 20 does not transmit and/or receive data at normal times. In a case that the UE 30 transmits the specific data, the UE 30 transmits the data to the second base station 20. In other words, in a case that the specific data is transmitted and/or received, information communication is performed between the second base stations 20 and the UE 30.

In the present embodiment, the second base station 20 is a dedicated base station configured to receive only the specific data from the multiple UEs 30. Therefore, the second base station 20 does not transmit and/or receive the normal data.

For example, in a case that the first base station 10 and the second base station 20 receive data from the UE 30, the first base station 10 and the second base station 20 may transmit the received data to an information processing apparatus (not illustrated). The information processing apparatus performs processing based on the received data. The information processing apparatus may include, for example, a server apparatus. The information processing apparatus may include, for example, a virtual server apparatus provided in a cloud. The information processing apparatus may be configured by using multi-access edge computing (MEC).

The UE 30 is a terminal apparatus. The UE 30 may include any apparatus capable of performing radio communication of data with the base stations. FIG. 1 schematically illustrates, as examples of the UEs 30, a mobile terminal apparatus 30a such as a smartphone, an in-vehicle apparatus 30b provided in a vehicle, an imaging apparatus 30c such as a monitoring camera, and a robot apparatus 30d used for manufacturing a product. However, the four apparatuses illustrated here are only examples of the UEs 30. The UEs 30 may include any other apparatus. In addition, FIG. 1 illustrates, as examples of the UEs 30, four apparatuses of the mobile terminal apparatus 30a, the in-vehicle apparatus 30b, the imaging apparatus 30c, and the robot apparatus 30d, but the number of the UEs 30 included in the communication system 1 is not limited to four. The communication system 1 may include one or more UEs 30.

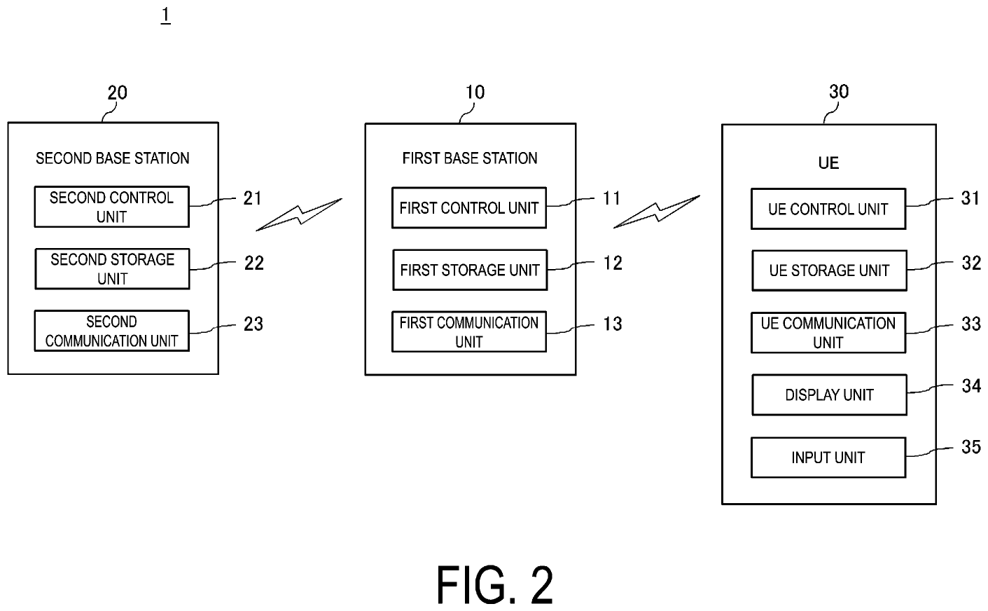

FIG. 2 is a function block diagram illustrating an example of configuration of the communication system 1 of FIG. 1. The mobile terminal apparatus 30a, the in-vehicle apparatus 30b, the imaging apparatus 30c, and the robot apparatus 30d illustrated in FIG. 1 are illustrates in FIG. 2 collectively as the UE 30.

As illustrated in FIG. 2, the first base station 10 includes a first control unit 11, a first storage unit 12, and a first communication unit 13 as functional units.

The first control unit 11 controls and manages the entire first base station 10 including the respective functional units of the first base station 10. The first control unit 11 includes at least one processor. The first control unit 11 includes a processor such as a Central Processing Unit (CPU) that executes a program defining a control procedure or a dedicated processor specialized in processing of each function.

In a case that a communication connection is newly established between the UE 30 and the first base station 10, the first control unit 11 transmits a message (hereinafter also simply referred to as an “MSGE”) indicating to transmit the specific data to the second base station 20, to the UE 30 with which the communication connection is newly established. The MSGE may include information for uniquely identifying the second base station 20. Since the MSGE includes the information for uniquely identifying the second base station 20, the UE 30 receiving the MSGE can recognize the second base station 20 which is a transmission destination of the specific data. The first control unit 11 controls radio communication of data between the first base stations 10 and the UE 30 with which the communication connection is established. The first control unit 11 perform processing for synchronizing data between the first base station 10 and the second base station 20.

The first storage unit 12 is a storage medium capable of storing programs and data. The first storage unit 12 can include, for example, a semiconductor memory, a magnetic memory, or the like. The first storage unit 12 may store, for example, a program for causing the first base station 10 to operate. In addition, the first storage unit 12 may store, for example, the information for uniquely identifying the second base station 20 included in the MSGE.

The first communication unit 13 transmits and/or receives data (radio signal) through radio communication via an antenna. The radio signal is used for data communication with the UE 30. Data communication between the first base station 10 and the UE 30 is performed the transmission and/or reception of the data. Prescribed processing is performed by the first control unit 11 on the data received by the first communication unit 13. The prescribed processing is known processing including, for example, AD conversion and Fourier transform. The first communication unit 13 transmits a radio signal generated by the first control unit 11 from the antenna.

As illustrated in FIG. 2, the second base station 20 includes a second control unit 21, a second storage unit 22, and a second communication unit 23 as functional units. The second base station 20 is a base station different from the first base station 10.

The second control unit 21 controls and manages the entire second base station 20 including the respective functional units of the second base station 20. The second control unit 21 includes at least one processor. The second control unit 21 includes a processor such as a CPU that executes a program defining a control procedure or a dedicated processor specialized in processing of each function.

In a case that a communication connection is newly established between the UE 30 and the first base station 10, the second control unit 21 may allocate a communication resource (for example, a frequency band) to the UE 30 with which the communication connection is newly established. The second control unit 21 may transmit, in advance, a UL grant for allowing uplink communication from the UE 30 to the second base stations 20, to the UE 30 with which the communication connection is newly established. The UE 30 with which the communication connection is newly established receives the UL grant from the second base station 20 to be enabled to communicate data with the second base station 20.

The second storage unit 22 is a storage medium capable of storing programs and data. The second storage unit 22 can include, for example, a semiconductor memory, a magnetic memory, or the like. The second storage unit 22 may store, for example, a program for causing the second base station 20 to operate.

The second communication unit 23 transmits and/or receives data through radio communication via an antenna. The radio signal is used for data communication with the UE 30. Data communication between the second base station 20 and the UE 30 is performed by the transmission and/or reception of the data. Prescribed processing is performed by the second control unit 21 on the data received by the second communication unit 23. The prescribed processing is known processing including, for example, AD conversion and Fourier transform. The second communication unit 23 transmits a radio signal generated by the second control unit 21 from the antenna.

As illustrated in FIG. 2, the UE 30 includes a UE control unit 31, a UE storage unit 32, a UE communication unit 33, a display unit 34, and an input unit 35 as functional units.

The UE control unit 31 controls and manages the entire UE 30 including the respective functional units of the UE 30. The UE control unit 31 includes at least one processor. The UE control unit 31 includes a processor such as a CPU that executes a program defining a control procedure or a dedicated processor specialized in processing of each function.

The UE control unit 31 determines whether data to be transmitted to the base station is specific data. Here, the specific data is data to be transmitted to the base station quickly or reliably. For example, the specific data is data predefined as the data with high urgency or importance. The information related to the data to be recognized as the data with high urgency or importance is predefined and stored in advance in the UE storage unit 32 described later, for example. To be more specific, for example, data indicating that an abnormality (for example, a failure) occurs in at least a part of the UE 30 is predefined as the data with high urgency or importance. Alternatively, in a case that the UE 30 is the mobile terminal apparatus 30a, an emergency call to police or a fire station is predefined as the data with high urgency or importance. In a case that the UE 30 is an imaging apparatus 30c, data indicating that a suspicious individual is included in a captured image is predefined as the data with high urgency or importance. In a case that the UE 30 is the robot apparatus 30d, data indicating that a foreign object is caught, data indicating that the robot apparatus 30d is brought to an emergency stop, or the like is predefined as the data with high urgency or importance.

For example, the UE control unit 31 may determine whether data to be transmitted to the base station is the specific data by referring to the UE storage unit 32. Specifically, the UE control unit 31 determines whether the data to be transmitted to the base station corresponds to the data with high urgency or importance that is stored in advance in the UE storage unit 32. The UE control unit 31, in a case of determining that the data to be transmitted to the base station corresponds to the data with high urgency or high importance stored in advance in the UE storage unit 32, determines that the data is the specific data. In contrast, the UE control unit 31, in a case of determining that the data to be transmitted to the base station does not correspond to the data with high urgency or high importance stored in advance in the UE storage unit 32, determines that the data is not the specific data, i.e., the data is normal data.

The UE control unit 31 may determine whether the data to be transmitted to the base station is the specific data by using a method other than the above-described method. For example, the UE control unit 31 may determine whether the data is the specific data in accordance with an algorithm stored in the UE storage unit 32. Alternatively, for example, the UE control unit 31 may determine whether the data is the specific data based on an input to the input unit 35 described later. Specifically, the UE control unit 31 may determine that data designated (input) as the specific data by the user using the input unit 35 is the specific data.

The UE control unit 31 controls transmission and/or reception of data to and from the base station by the UE communication unit 33. Specifically, the UE control unit 31 transmits data (normal data) from the UE communication unit 33 to the first base station 10 at normal times except for a case that the UE control unit 31 determines that the data is the specific data. The UE control unit 31, in the case of determining that the data is the specific data, transmits the specific data from the UE communication unit 33 to the second base station 20.

The UE storage unit 32 is a storage medium capable of storing programs and data. The UE storage unit 32 can include, for example, a semiconductor memory, a magnetic memory, or the like. The UE storage unit 32 may store, for example, a program for causing the UE 30 to operate.

The UE storage unit 32 stores, for example, information that is to be determined as the specific data and is related to the data with high urgency or importance. The UE storage unit 32 may store, for example, the algorithm used for the UE control unit 31 to determine whether the data is the specific data.

The UE communication unit 33 transmits and/or receives data through radio communication via an antenna. Data communication between the first base station 10 or the second base station 20 and the UE 30 is performed by the transmission and/or reception of the data. In the present embodiment, the UE communication unit 33 can transmit data to the first base station 10 and the second base station 20. Prescribed processing is performed by the UE control unit 31 on the data received by the UE communication unit 33. The prescribed processing is known processing including, for example, AD conversion and Fourier transform. The UE communication unit 33 transmits a radio signal, for the data, generated by the UE control unit 31 from the antenna.

The display unit 34 includes a display device such as a Liquid Crystal Display, an organic EL panel (Organic Electro-Luminescence Panel), or an inorganic EL panel (Inorganic Electro-Luminescence panel). The display unit 34 displays characters, images, symbols, figures, or the like. The display unit 34 may include a touch screen display having not only a display function but also a touch screen function. In this case, a touch screen detects contact of a finger of a user of the UE 30, a stylus pen, or the like.

The input unit 35 receives an operation input from the user of the UE 30. The input unit 35 includes, for example, an operation button (operation key). The input unit 35 may include a touch screen, and an input region for accepting an operation input from the user may be displayed on a part of the display device which is the display unit 34 to accept a touch operation input from the user. For example, the input unit 35 may accept an operation input for designating the specific data from the user. In this case, the data designated by the operation input of the user is recognized as the specific data, and the processing is performed. For example, in a case that the user performs an operation of inputting the data with high urgency or importance to the UE 30 and transmitting that data from the UE 30, the user can perform an operation input for designating that data as the specific information.

In addition to the functional units described with reference to FIG. 2, the UE 30 may appropriately include functional units required to perform specific functions. For example, in the case that the UE 30 is the imaging apparatus 30c, the imaging apparatus 30c may include an imaging unit for capturing an image. For example, in the case that the UE 30 is the robot apparatus 30d, the robot apparatus 30d may include a mechanism for manufacturing a product, a sensor for detecting an abnormality in a manufacturing process, and the like. The UE 30 is not limited to the examples illustrated here, and may include an appropriate functional unit in accordance with the application or the like.

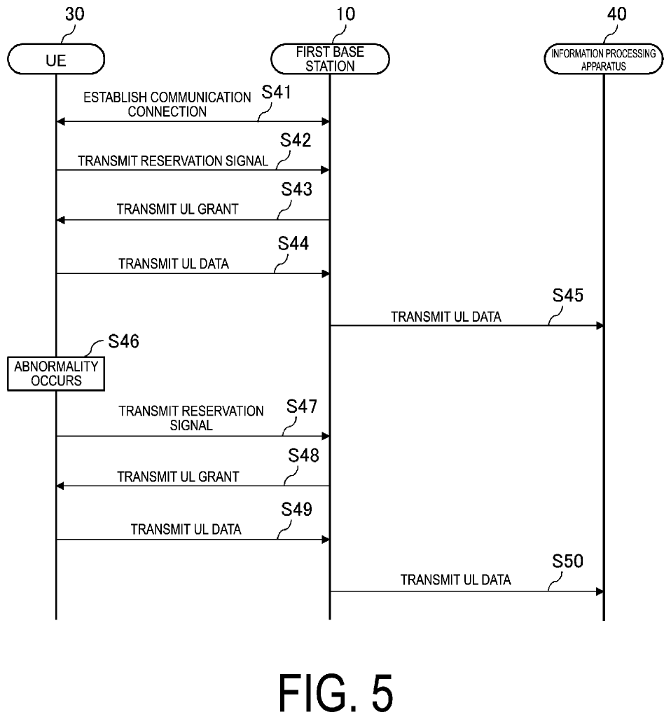

Next, an example of processing performed by the communication system is described. First, for comparison with the communication system 1 according to the present disclosure, an example of processing by a known communication system is described. FIG. 5 is a sequence diagram illustrating an example of the processing by the known communication system. Unlike the present embodiment, the sequence illustrated in FIG. 5 illustrates processing in the case that communication is performed only between the UE 30 and the first base stations 10. In other words, in the example illustrated in FIG. 5, the second base station 20 does not exist.

First, a communication connection is established between the first base station 10 and the UE 30 (step S41).

Assume that in a state where a communication connection is established between the first base station 10 and the UE 30, the UE 30 transmits uplink communication data (hereinafter also simply referred to as “UL data”) to the first base station 10. Here, assume that the UE 30 transmits the UL data, which is classified as the “normal data” in the above embodiment, to the first base stations 10. In this case, the UE 30 transmits to the first base station 10 a reservation signal to request a resource for transmitting the UL data (step S42). The reservation signal may be a known reservation signal, such as a scheduling request or a buffer status report.

The first base station 10, in a case of receiving the reservation signal from the UE 30, transmits to the UE 30 a UL grant to allow an uplink communication from the UE 30 to the first base station 10 (step S43). As a result, a resource for the uplink communication to the first base stations 10 is allocated to the UE 30.

The UE 30, in a case of receiving the UL grant, transmits the UL data to the first base station 10 (step S44). In this way, the UL data is transmitted from the UE 30 to the first base station.

The first base station 10, in a case of receiving the UL data from the UE 30, transmits that UL data to an information processing apparatus 40 (step S45). The information processing apparatus 40 includes, for example, a server apparatus and performs processing based on the received UL data.

In the case that the UE 30 transmits the UL data, the processing of steps S42 to S45 is performed each time.

Next, assume that an abnormality occurs in the UE 30 (step S46). The data indicating that an abnormality occurs is UL data determined to be the “specific data” in the above embodiment. However, in the example illustrated in FIG. 5, the UE 30 may or may not determine that the data indicating that the abnormality occurs is the specific data. This is because, in the example illustrated in FIG. 5, even in the case the data is determined to be the specific data, the data is transmitted to the first base station 10.

In other words, in a case that the UE 30 transmits, as the UL data, the data indicating that the abnormality occurs, the UE 30 transmits to the first base station 10 a reservation signal to request a resource for transmitting the UL data (step S47).

The first base station 10, in a case of receiving the reservation signal from the UE 30, transmits to the UE 30 a UL grant to allow an uplink communication from the UE 30 to the first base station 10 (step S48).

The UE 30, in a case of receiving the UL grant, transmits the UL data to the first base station 10 (step S49). In this way, the data indicating that an abnormality occurs is transmitted from the UE 30 to the first base station.

The first base station 10, in a case of receiving the UL data from the UE 30, transmits that UL data to the information processing apparatus 40 (step S50).

The details of steps S47 to S50 in FIG. 5 are the same as those of steps S42 to S45, respectively. In other words, in the example illustrated in FIG. 5, the UL data is transmitted from the UE 30 to the first base station 10 regardless of the content of the UL data. However, for example, in a case that the number of UEs 30 having the communication connections with the first base stations 10 increases, congestion may occur in communication between the UEs 30 and the first base station 10. In a case that communication congestion occurs, the communication becomes unstable, and there is a possibility that a problem occurs in that the UL data cannot be transmitted to the first base station 10 or even in a case that the UL data can be transmitted, it takes time. It is desirable to avoid such a problem, particularly in the case of transmitting the specific data with high urgency or importance. According to the communication system 1 of the present embodiment, such a problem can be avoided, the arrival time of communication can be reduced, and the stability or reliability of communication can be improved.

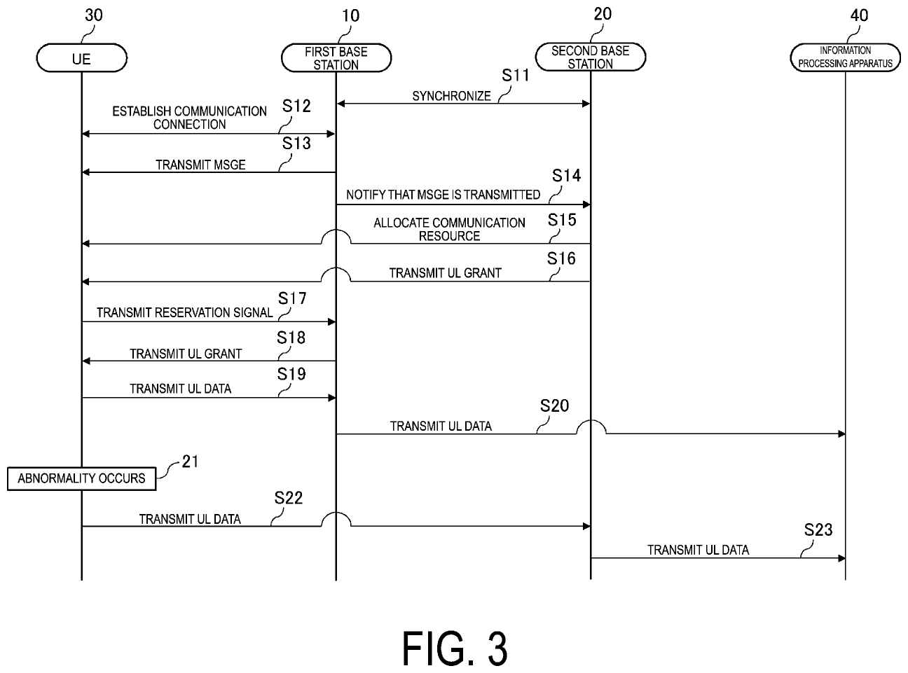

FIG. 3 is a sequence diagram illustrating an example of the processing by the communication system 1 of FIG. 2 according to the present embodiment. FIG. 3 illustrates an example of a communication method in the present disclosure.

First, data is synchronized between the first base station 10 and the second base station 20 (step S11). The synchronization of the data between the first base station 10 and the second base station 20 may be performed regularly or as appropriately in the flow illustrated in FIG. 3. Next, assume that a communication connection is established between the first base station 10 and the UE 30 (step S12).

The UE 30 acquires a communication resource for the second base stations 20 in advance in a case that the communication connection with the first base stations 10 is established. For example, in the present embodiment, after the communication connection is established between the first base station 10 and the UE 30 in step S12, the communication resource for the second base station 20 is acquired in advance by the UE 30 in steps S13 to S16.

In other words, in a case that a communication connection is newly established between the first base station 10 and the UE 30, the first base station 10 transmits, to the UE 30, an MSGE indicating to transmit the specific data to the second base station 20 (step S13).

The first base station 10 notifies the second base station 20 that the MSGE is transmitted to the UE 30 (step S14). The notification may include information for uniquely identifying the UE 30. Thus, the second base station 20 can recognize that the first base station 10 establishes a connection with a new UE 30.

The second base station 20, in a case of receiving the notification indicating that the MSGE is transmitted to the UE 30, allocates a communication resource to the UE 30 (step S15).

The second base station 20 transmits, to the UE 30, a UL grant that allows an uplink communication from the UE 30 to the second base station 20 (step S16).

In a case that the UE 30 has received the allocation of the communication resource from the second base station 20 and has received the UL grant, the UE 30 is in a state of being able to transmit the UL data to the second base station 20.

Note that the first base station 10 may not necessarily perform step S14. In other words, the first base station 10 may not necessarily notify the second base station 20 that the MSGE is transmitted to the UE 30. For example, the data being synchronized between the first base station 10 and the second base station 20 allows the second base station 20 to recognize that a communication connection is newly established between the first base station 10 and the UE 30. In this case, the second base station 20 may perform steps S15 and S16 in a case that the second base station 20 recognizes that a communication connection is newly established between the first base station 10 and the UE 30. The processing may be performed in any procedure, as long as the UE 30 can acquire in advance the communication resource for the second base station 20 in a case that the communication connection with the first base station 10 is established in step S12.

Next, assume that the UE 30 transmits the UL data to the first base station 10. In this case, the UE 30 determines whether the UL data to be transmitted is the specific data. In a case that the UE 30 determines that the UL data to be transmitted is not the specific data, in other words, determines that the UL data to be transmitted is the normal data, the UE 30 transmits to the first base station 10 a reservation signal to request a resource for transmitting the UL data (step S17).

The first base station 10, in a case of receiving the reservation signal from the UE 30, transmits to the UE 30 a UL grant to allow an uplink communication from the UE 30 to the first base station 10 (step S18). As a result, a resource for the uplink communication to the first base stations 10 is allocated to the UE 30.

The UE 30, in a case of receiving the UL grant, transmits the UL data to the first base station 10 (step S19). In this way, the UL data is transmitted from the UE 30 to the first base station.

The first base station 10, in a case of receiving the UL data from the UE 30, transmits the UL data to the information processing apparatus 40 (step S20). The information processing apparatus 40 includes, for example, a server apparatus and performs processing based on the received UL data.

The details of steps S17 to S20 in FIG. 3 are the same as those of steps S42 to S45 in FIG. 5, respectively.

In a case that the UE 30 transmits the normal data, the processing of steps S17 to S20 is performed.

Next, assume that abnormality occurs in the UE 30 (step S21). In this case, the UE 30 determines that the data indicating that abnormality occurs is the specific data.

In a case that the UE 30 determines that the UL data to be transmitted is the specific data, the UE 30 transmits the UL data to the second base station 20 by using the communication resource for the second base station 20 acquired in step S15 (step S22).

The second base station 20, in a case of receiving the UL data from the UE 30, transmits that UL data to the information processing apparatus 40 (step S23). The information processing apparatus 40 includes, for example, a server apparatus and performs processing based on the received UL data.

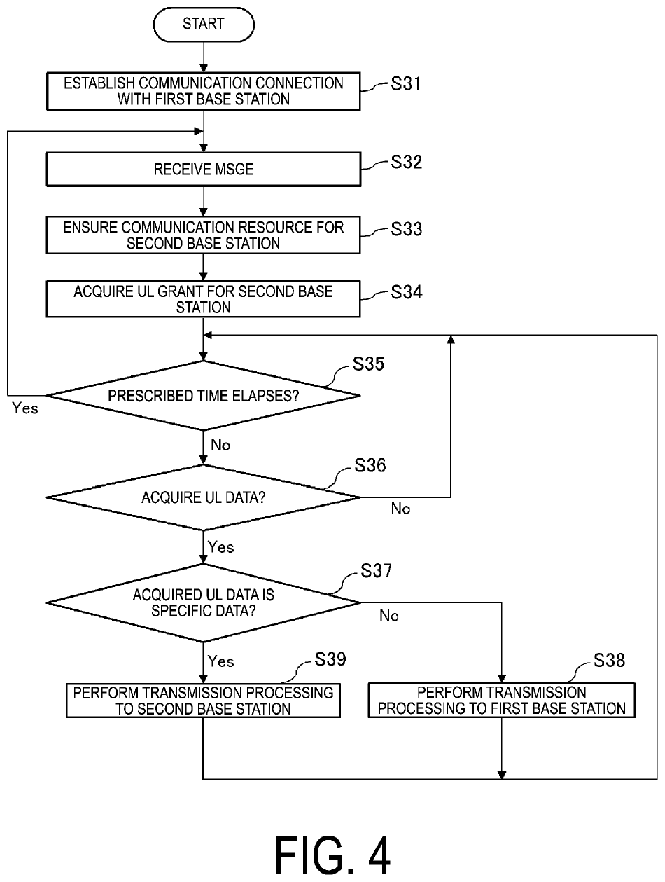

FIG. 4 is a flowchart illustrating an example of the processing performed by the UE 30 of FIG. 2. Assume that a communication connection is not established between the UE 30, and the first base station 10 and the second base station 20 at the start of the flow of FIG. 4.

First, the UE 30 establishes a communication connection with the first base station 10 (step S31).

In a case that the communication connection is established between the UE 30 and the first base station 10, an MSGE is transmitted from the first base station 10 as described in step S13 of FIG. 3. The UE 30 receives the MSGE transmitted from the first base station 10 (step S32).

As described in step S15 of FIG. 3, a communication resource is allocated from the second base station 20 to the UE 30. As a result, the UE 30 ensures the communication resource for the second base station 20 (step S33).

Further, as described in step S16 of FIG. 3, a UL grant is transmitted from the second base station 20 to the UE 30. The UE 30 acquires the UL grant transmitted from the second base station 20 (step S34). As a result, the UE 30 becomes in the state of being able to transmit the UL data to the second base station 20.

Next, the UE 30 determines whether a prescribed time elapses after receiving the MSGE in step S32 (step S35). The prescribed time may be defined as appropriate, and may be configured in a range from several minutes to several hours, for example. The prescribed time may be configured to a time during which a communication state of the first base station 10 or the second base station 20 may change.

In a case that the UE 30 determines that the prescribed time elapses (Yes in step S35), the process proceeds to step S32 and the UE 30 receives the MSGE from the first base station 10 again. For example, the first base station 10 may transmit the MSGE again in the case that a prescribed time elapses after transmitting the MSGE to the UE 30, and the UE 30 may receive the MSGE transmitted again in step S32. Alternatively, in the case that the UE 30 determines that the prescribed time elapses, the UE 30 may transmit a retransmission request of the MSGE to the first base station 10, and the first base station 10 may transmit the MSGE to the UE 30 again, based on the retransmission request.

In this case, the second base stations 20 allocate a communication resource and transmits a UL grant to the UE 30 again. Based on these processes of the second base station 20, the UE 30 ensures the communication resource for the second base station 20 (step S33) and acquires the UL grant for the second base station 20 (step S34). In this way, the UE 30 becomes in the state of being able to transmit the UL data to the second base station 20 again. In particular, in a case that the UE 30 determines that the prescribed time elapses in the step S35 and thus performs from the step S32 the step S34 again, the communication resource or the like allocated to the UE 30 may be changed from the initially allocated communication resource. In this way, in a case that a state of the communication connection of the second base station 20 with another UE 30 changes due to the prescribed time elapsing, an appropriate communication resource depending on the latest state of the communication connection is allocated to the UE 30.

In a case that the UE 30 determines, in step S35, that the prescribed time does not elapse (No in step S35), the UE 30 determines whether the UE 30 has acquired the UL data to be transmitted to the base station (step S36). For example, the UE 30 can acquire the UL data by a sensor or the like included in the UE 30, acquire the UL data based on the UE 30 completing a prescribed process, acquire the UL data based on the operation input of the user received from the input unit 35, or acquire the UL data by performing information communication with an external device. The UE 30 may acquire the UL data to be transmitted to the base station by an arbitrary method other than the above-described example.

In a case that the UE 30 determines that the UE 30 has not acquired the UL data (No in step S36), the process proceeds to step S53 and the UE 30 determines whether the prescribed time elapses.

On the other hand, in a case that the UE 30 determines that the UE 30 has acquired the UL data (Yes in step S36), the UE 30 determines whether the UL data is the specific data (step S37).

In a case that the UE 30 determines that the UL data is not the specific data (No in step S37), the UE 30 performs a process of transmitting the UL data to the first base station 10 (step S38). To be more specific, the process of transmitting the UL data to the first base station 10 is performed in the processing of steps S17 to S19 in FIG. 3. Then, the process of the UE 30 proceeds to step S35.

On the other hand, in a case that the UE 30 determines that the UL data is the specific data (Yes in step S37), the UE 30 performs a process of transmitting the UL data to the second base station 20 (step S39). To be more specific, as described in step S22 of FIG. 3, the UL data is directly transmitted from the UE 30 to the second base station 20. Then, the process of the UE 30 proceeds to step S35.

In the communication system 1 of the present embodiment, the UE 30, in the case of determining that the UL data is the specific data, transmits the specific data to the second base station 20 different from the first base station 10. Therefore, even in a case that congestion occurs in the communication with the first base station 10 for transmitting and/or receiving the normal data, the specific data can be transmitted from the UE 30 to the second base station 20 without being affected by the congestion. In other words, the stability or reliability of communication can be improved in the transmission of the specific data. In particular, in a case that the second base station 20 is a dedicated base station configured to receive only the specific data as in the present embodiment, quickness and stability of communication can be easily ensured for the specific data with high urgency or importance, and the arrival time of communication can be reduced.

As in the present embodiment, the UE 30 acquires the communication resource for the second base station 20 in advance in a case that the communication connection is established between the UE 30 and the first base station 10, so that the UE 30 need not ensure the communication resource or be authenticated in a case that a need to transmit the specific data arises. Therefore, the UE 30 can quickly transmit the specific data.

In the above embodiment, some processes may not be performed and may be omitted. For example, step S35 in the flow of FIG. 4 may be omitted. To be more specific, for example, step S35 may be omitted in an environment in which a variation is small in the state of the communication connection of the second base stations 20. This is because even in a case that step S35 is omitted, the communication connection between the UE 30 and the second base station 20 can be satisfactorily maintained.

For example, step S15 in the sequence of FIG. 3 and step S33 in the flow of FIG. 4 may be omitted. For example, in a case that the MSGE transmitted to the UE 30 in step S13 in the sequence of FIG. 3 includes information on the communication resource used for the communication with the second base station 20, the UE 30 can establish a communication connection with the second base station 20 even in a case that step S15 in the sequence of FIG. 3 and step S33 in the flow of FIG. 4 are omitted.

For example, step S16 in the sequence of FIG. 3 and step S34 in the flow of FIG. 4 may be omitted. For example, in a case that the second base station 20 always releases a communication resource dedicated to a specific uplink communication, step S16 in the sequence of FIG. 3 and step S34 in the flow of FIG. 4 may be omitted. To be more specific, the second base station 20 may be a base station of a grant-free scheme that is capable of performing communication with the UE 30 without granting in advance, for example. In a case that the second base station 20 is of the grant-free scheme, the UE 30 can transmit the specific data to the second base station 20 without being granted in advance. Therefore, in the case that the second base station 20 is of the grant-free scheme, step S16 in the sequence of FIG. 3 and step S34 in the flow of FIG. 4 may be omitted.

The above embodiment describes that the UE 30, in a case of determining that the UL data is the specific data, transmits that UL data to the second base station 20 (steps S37 and S39 in FIG. 4). The UE 30, in the case of determining that the UL data is the specific data, may perform a process indicating that the UL data is the specific data. For example, the UE 30, in the case of determining that the UL data is the specific data, may configure a flag in the UL data. This flag indicates that the UL data in which the flag is configured is the specific data. Alternatively, for example, the UE 30, in the case of determining that the UL data is the specific data, may perform a process of changing a state of a bit of a part of the UL data to a specific state indicating that the UL data is the specific data. The flag being configured or the state of the bit being changed in this way allows the UE 30 to recognize that the UL data is the specific data. The UE 30 transmits the UL data in which the flag is configured or the state of the bit is changed to the second base station 20. This can implement the same processing as the above embodiment.

Although the present disclosure has been described based on the drawings and the embodiments, it should be noted that those skilled in the art can easily make various changes and modifications based on the present disclosure. Therefore, it should be noted that these changes and modifications are included in the scope of the present disclosure. For example, the function or the like included in each functional unit, each step, or the like can be rearranged so as not to be logically inconsistent, and multiple functional units, steps, or the like can be combined into one or divided.

1. A User Equipment (UE) comprising:
a communication unit configured to transmit data to a first base station; and
a control unit configured to control transmission of data by the communication unit, wherein
the control unit determines whether the data is specific data, and in a case of determining that the data is the specific data, transmits the specific data from the communication unit to a second base station different from the first base station.

2. The UE according to claim 1, wherein
the control unit, in a case of determining that the data is not the specific data, transmits the data from the communication unit to the first base station.

3. The UE according to claim 1, wherein
the specific data is data predefined as data with high urgency or importance.

4. The UE according to claim 1, wherein
the UE acquires a communication resource for the second base station in advance in a case that a communication connection is established between the UE and the first base station.

5. The UE according to claim 1, wherein
stored data is synchronized between the first base station and the second base station.

6. A communication system comprising:
a first base station;
a second base station different from the first base station; and
a User Equipment (UE) configured to transmit data to the first base station, wherein
the UE determines whether the data is specific data, and in a case of determining that the data is the specific data, transmits the specific data to the second base station.

7. A communication method performed by a User Equipment (UE) configured to transmit data to a first base station, the communication method comprising the steps of:
determining whether the data is specific data; and
transmitting, in a case that the data is determined to be the specific data, the specific data to a second base station different from the first base station.
